(19) United States
(12) Patent Application Publication
(10) Pub. No.: US 2003/0103535 A1
(43) Pub. Date: Jun. 5, 2003

(54) Guide member and method for mounting light emitter to circuit board

(75) Inventor: Toshio Kasai, Tokyo (JP)

Correspondence Address: GREENBLUM & BERNSTEIN, P.L.C., 1950 ROLAND CLARKE PLACE, RESTON, VA, 20191, US

(73) Assignee: PENTAX Corporation, Tokyo (JP)

(21) Appl. No.: 10/303,895

(22) Filed: Nov. 26, 2002

(30) Foreign Application Priority Data
Dec. 4, 2001 (JP) 2001-369721

(51) Int. Cl. H01S 3/04

(52) U.S. Cl. 372/36

(57) ABSTRACT

A guide member provided between at least one light emitting element located at a predetermined position and a circuit board, the light emitting element is provided with a plurality of lead wires, the circuit board is provided with a plurality of insertion holes in which a plurality of the lead wires of the light emitting element are inserted, respectively, and the guide member is provided with a plurality of guide holes through which each lead wire of the light emitting element is guided into each corresponding insertion hole of the plurality of insertion holes of the circuit board. A mounting method for mounting the light emitting element is also disclosed.

### BACKGROUND OF THE INVENTION

1. Field of the Invention

The present invention relates to a guide member for mounting a light emitting element to a circuit board and a mounting method thereof, in a scanning optical system.

2. Description of the Related Art

For example, in an optical scanner used in a monochromatic laser printer, laser light emitted from a semiconductor laser (laser diode [LD]) is irradiated onto a surface of a photosensitive drum through a collimator lens, a polygonal mirror and an fθ lens. In such an optical scanner, the LD is supported by a supporting frame whose position relative to a holder frame which holds the collimator lens is adjusted in an adjusting stage to align the emission center of the LD with the center axis of the collimator lens.

In a multi-beam scanning optical system used in a color printer having four LDs (for yellow, cyan, magenta, black), each LD has a supporting frame, and therefore the adjusting operation must be carried out for each LD. After completion of the adjusting operations, each lead wire of the LDs is inserted in an insertion hole of a LD drive circuit board and is soldered to a circuit pattern formed on the LD drive circuit board. Thus, the LDs are mounted to the LD drive circuit board. However, as a result of the adjusting operations, there is a possibility that the position of the front ends of the lead wires of the LDs is deviated from a correct designed position due to irregularity of the supporting frames and/or the lens holder frame and irregularity of the emission centers of the LDs. Consequently, it is difficult to insert the lead wires of all the LDs into the insertion holes of the LD drive circuit board which are correctly formed in a design position. To solve this problem, in the prior art, the LDs are mounted to respective separate LD drive circuit boards or the LDs are connected to a common LD drive circuit board using a flexible circuit board.

However, if each LD has an individual LD drive circuit board, the number of the LD drive circuit boards is increased, thus leading to an increase in the size of the apparatus. Moreover, if the LDs are connected to the LD drive circuit board via the flexible circuit board, the distance between the LDs and the LD drive circuit board is increased, and hence, the output property of the LDs is deteriorated.

### SUMMARY OF THE INVENTION

To eliminate the drawbacks of the prior art mentioned above, the present invention provides a guide member which can be used to mount a plurality of light emitting elements to a circuit board and a method for mounting a plurality of light emitting elements to a circuit board.

For example, a guide member is provided between at least one light emitting element located at a predetermined position and a circuit board, the light emitting element is provided with a plurality of lead wires, the circuit board is provided with a plurality of insertion holes in which a plurality of said lead wires of the light emitting element are inserted, respectively, and the guide member is provided with a plurality of guide holes through which each lead wire of the light emitting element is guided into each corresponding insertion hole of the plurality of insertion holes of the circuit board.

The guide holes can extend through the guide member from a first surface of the guide member adjacent to the light emitting element to a second surface of the guide member adjacent to the circuit board, the diameter of the guide hole at the second surface being smaller than the diameter of the guide hole at the first surface.

It is desirable for the guide holes to be tapered so that the diameter thereof is decreased from the first surface of the guide member adjacent to the light emitting element toward the second surface of the guide member adjacent to the circuit board.

It is desirable for the diameter of the guide hole at the second surface to be not greater than the diameter of the insertion holes.

In another aspect of the present invention, a mounting method is provided for mounting at least one light emitting element to a circuit board by inserting a plurality of lead wires of the light emitting element in corresponding insertion holes formed in the circuit board, wherein a guide member is provided between the light emitting element and the circuit board, the guide member being provided with a plurality of tapered guide holes whose diameter is reduced from a first surface of the guide member opposed to the light emitting element toward a second surface thereof opposed to the circuit board, the mounting method including inserting each lead wire of the light emitting element into the corresponding guide hole of the guide member, and inserting the lead wires extending from the guide holes into the corresponding insertion holes of the circuit board.

The light emitting element can be mounted to the guide member in advance by inserting the lead wires of the light emitting element into the corresponding guide holes of the guide member, and thereafter, the lead wires extending from the guide holes are inserted in the corresponding insertion holes.

The guide member can be secured to the circuit board in advance so that the guide holes in the second surface of the guide member are registered with the corresponding insertion holes of the circuit board, and thereafter, the lead wires of the light emitting elements are inserted in the corresponding insertion holes by inserting the lead wires in the corresponding guide holes.

The present disclosure relates to subject matter contained in Japanese Patent Application No.2001-369721 (filed on Dec. 4, 2001) which is expressly incorporated herein by reference in its entirety.

### BRIEF DESCRIPTION OF THE DRAWINGS

The invention will be discussed below with reference to the accompanying drawings, in which:

FIG. 1 is a plan view of a multi-beam scanning optical system which is mounted to a color printer, to which an embodiment of the present invention is applied;

FIG. 2 is an enlarged plan view of a laser unit shown in FIG. 1;

FIG. 3 is a schematic view showing a positional relationship between LDs and collimator lenses, provided in a laser unit shown in FIG. 2;

FIG. 4 is a plan view of a laser unit (without an LD drive circuit board) shown in FIG. 2, as viewed from the LD side;

FIG. 5 is a schematic sectional view showing a mounting operation of an LD to an LD drive circuit board, by way of example; and

FIG. 6 is a schematic view of a guide member according to the present invention.

### DESCRIPTION OF THE PREFERRED EMBODIMENTS

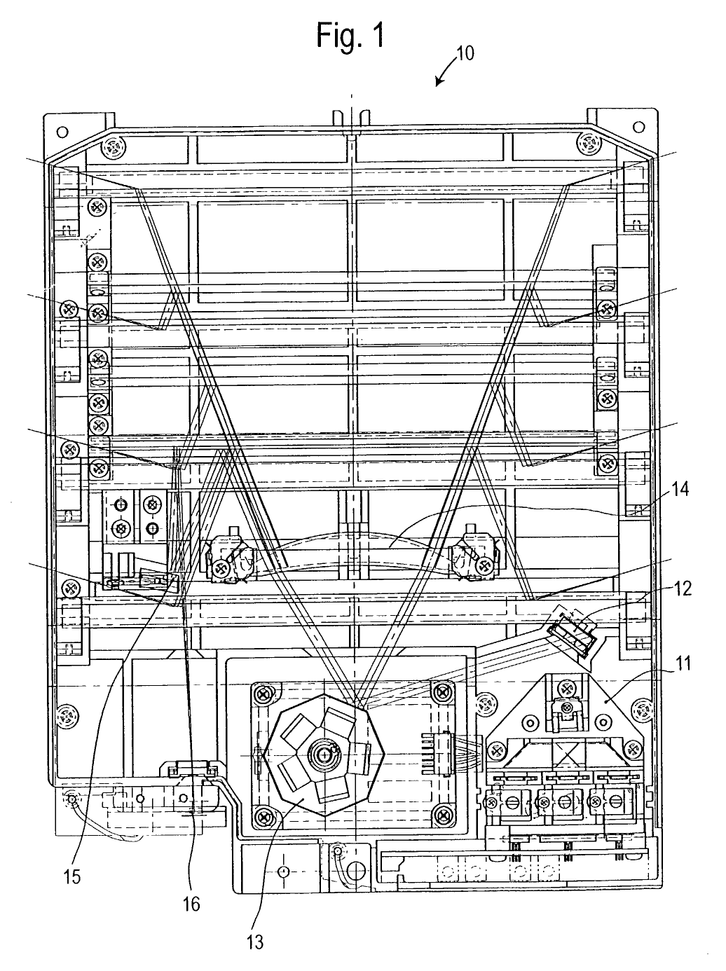

FIG. 1 shows an embodiment of the invention, applied to a multi-beam scanning optical system 10 mounted to a color printer. The multi-beam scanning optical system 10 includes a laser unit 11, a collimating mirror 12, a polygonal mirror 13, an fθ lens 14, a mirror portion 15 and a synchronization detection portion 16. The laser unit 11 is provided with four laser diodes (LDs/light emitting elements) 20 (20A through 20D) and emits four laser beams respectively. Each laser beam emitted from the laser unit 11 is reflected by the collimating mirror 12 and is made incident upon the polygonal mirror 13 which rotates at high speed, so that the laser beams scan in a lateral direction of the multi-beam scanning optical system 10. The laser beams reflected by the polygonal mirror 13 are transmitted through the fθ lens 14 and are reflected by a mirror to scan four photosensitive drums (not shown) which are located on respective light paths of the reflected light beams. Note that the laser light reflected by the polygonal mirror 13 is partly received by the synchronization detection portion 16 through the mirror portion 15. In the illustrated embodiment, the writing timing can be synchronized by the synchronization detection portion 16.

The laser unit 11 according to the present invention will be discussed below in detail.

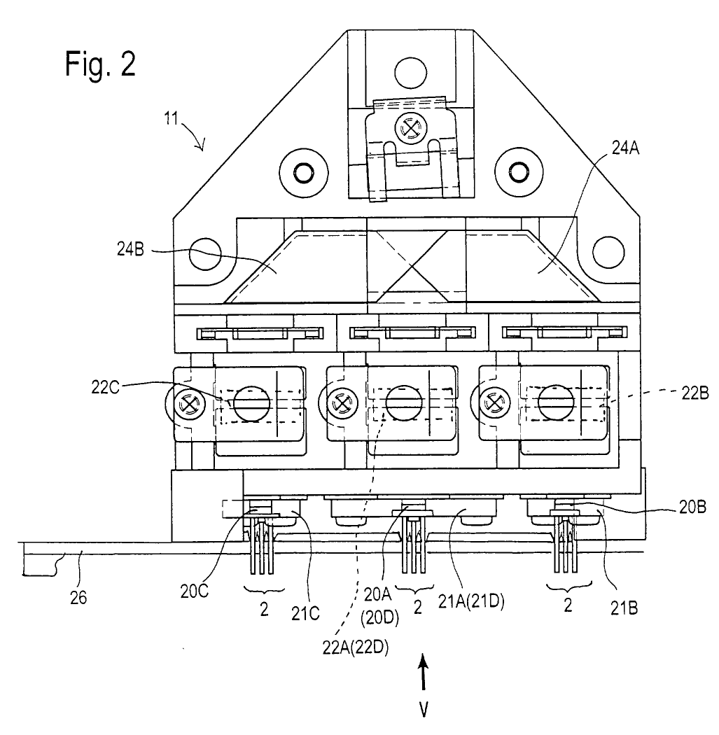

In FIG. 2 which shows an enlarged view of the laser unit 11, the laser unit 11 includes the four LDs 20A through 20D, four collimator lenses 22 (22A through 22D), two prisms 24A, 24B, and a single LD drive circuit board 26.

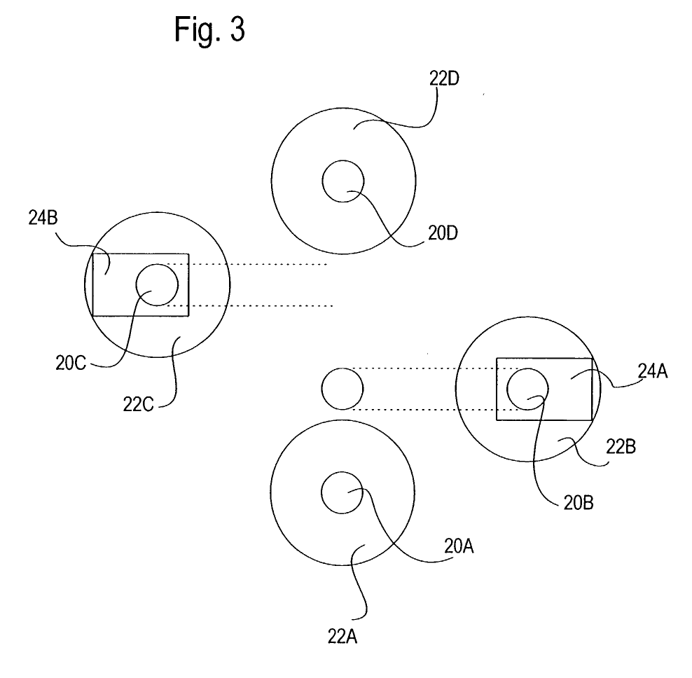

The LDs 20A through 20D are supported by respective supporting frames 21 (21A through 21D). As shown in FIG. 3, the LDs 20A and 20D are arranged so that the emission surfaces thereof are spaced in parallel in the vertical direction (upward and downward direction in FIG. 3). The LDs 20B and 20C are arranged so that the emission surfaces are spaced in parallel in the vertical direction (upward and downward direction in FIG. 3) and are located on opposite sides of a straight line connecting the centers of the LD 20A and the LD 20D. The distance between the adjacent emission surfaces of the four LDs 20A through 20D in the vertical direction (upward and downward direction in FIG. 3) is substantially the same.

The collimator lenses 22A through 22D are supported by the lens holder frame 23 and are located in front of the LDs 20A through 20D. The collimator lenses 22A through 22D collimate the laser light emitted from the LDs 20A through 20D, respectively. The prisms 24A and 24B are adapted to shift the optical axes of the collimator lenses 22B and 22C so as to be aligned in parallel, so that the optical axes of the collimator lenses 22B and 22C and the optical axes of the collimator lenses 22A and 22D are made parallel at the emission surfaces thereof. Namely, the four laser lights passing through the collimator lenses 22A through 22D are emitted from the laser unit 11 in parallel and at an equal distance in the vertical direction.

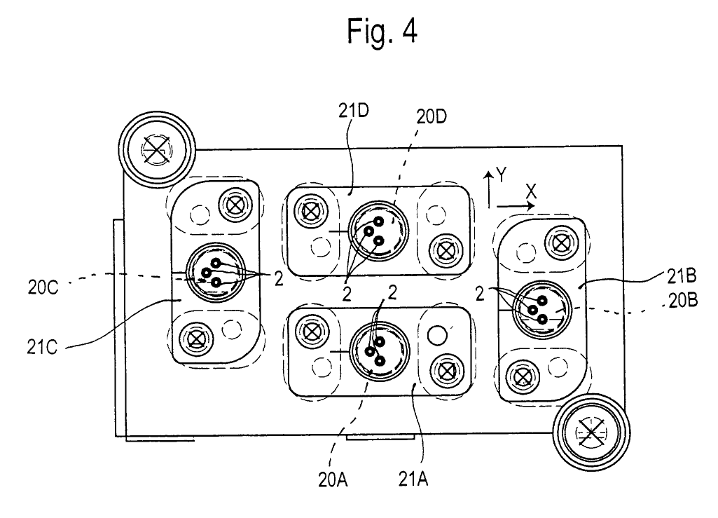

The positions of the supporting frames 21A through 21D which support the LDs 20A through 20D relative to the lens holder frame 23 are adjusted in the directions X and Y in FIG. 4, so that the emission axes of the LDs 20A through 20D are aligned with the corresponding optical axes of the collimator lenses 22A through 22D. After adjustment, the supporting frames 21A through 21D are secured to the lens holder frame 23 by screws. FIG. 4 shows the laser unit 11 in which the supporting frames 21A through 21D are secured (before the LD drive circuit board 26 is mounted), as viewed from an arrow V shown in FIG. 2.

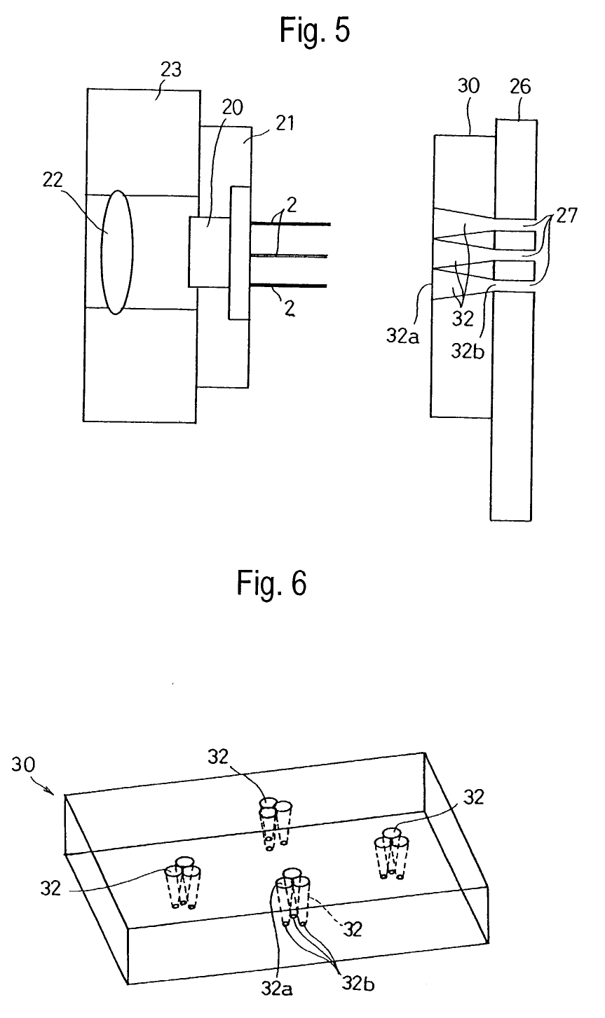

Three lead wires 2 which can be connected to the LD drive circuit board 26 extend from the rear end of each LD 20 (20A through 20D). The LD drive circuit board 26 is provided thereon with circuit elements such as a drive circuit for driving the LDs 20A through 20D, and insertion holes 27 (shown in FIG. 5) in which the lead wires 2 of the LDs 20A through 20D are inserted. The LDs 20A through 20D and the LD drive circuit board 26 are connected to each other by inserting the lead wires 2 of the LDs 20A through 20D in the corresponding insertion holes 27 and soldering the lead wires to the circuit pattern of the LD drive circuit board 26.

However, since the connection is carried out after the LDs 20A through 20D and the collimator lenses 22A through 22D are assembled into an integral unit, the positions of the front ends of the lead wires 2 of the LDs 20A through 20D may be deviated from designed correct positions as a result of the positional adjustment of the LDs 20A through 20D relative to the collimator lenses 22A through 22D. Moreover, the lead wires 2 of the LDs 20A through 20D may bend during an assembling operation. If the positional deviation of the lead wires 2 at the front ends thereof occurs, it is difficult to insert all the lead wires 2 (3×4=12 wires in the illustrated embodiment) of the LDs 20A through 20D in the insertion holes 27 of the LD drive circuit board 26 because the relative position of the LDs 20A through 20D cannot be adjusted. It is possible to arrange the collimator lenses 22A through 22D after the LDs 20A through 20D are connected to the LD drive circuit board 26. However, in this alternative, it is difficult to adjust the relative position of the LDs 20A through 20D and the collimator lenses 22A through 22D, and hence, it is difficult to align the optical axes of the collimator lenses 22A through 22D with the emission centers of the LDs 20A through 20D.

In the illustrated embodiment, as can be seen in FIG. 5, a guide member 30 is provided between the LDs 20A through 20D and the LD drive circuit board 26, so that the lead wires 2 of the LDs 20A through 20D can be easily inserted in the corresponding insertion holes 27 of the LD drive circuit board through the guide member 30.

FIG. 6 schematically shows the guide member 30. The guide member 30 is provided with guide through holes 32 which are tapered to reduce the diameter from large openings 32a, at a first surface of the guide member 30 opposed to the LDs 20A through 20D, toward small openings 32b at a second surface of the guide member 30 opposed to the LD drive circuit board 26. The guide holes 32 are formed corresponding to the insertion holes 27 of the LD drive circuit board 26 as clearly shown in FIG. 5. Namely, the diameter of the small openings 32b of the guide holes 32 is the same or smaller than the diameter of the insertion holes 27. When the guide member 30 is secured to the LD drive circuit board 26, the guide holes 32 are connected to the corresponding insertion holes 27. Since the guide member 30 have the tapered guide holes 32, the front ends of the lead wires 2 can be easily inserted in the large openings 32a of the guide holes 32, even if the front ends of the lead wires of the LDs 20A through 20D are deviated from the corresponding insertion holes 27. Consequently, the lead wires 2 are guided along the inner peripheral surfaces of the guide holes 32 while adjusting the position of the front ends thereof, so that the lead wires 2 can be precisely inserted in the insertion holes 27 through the small openings 32b of the guide holes 32. Note that the guide member 30 also provides a distance between the LDs 20A through 20D and the LD drive circuit board 26 to thereby reduce the stress of the lead wires 2 of the LDs 20A through 20D.

In the above-described structure, the LDs 20A through 20D are connected to the LD drive circuit board 26 as follows.

<First Step>

The LDs 20A through 20D are inserted in and secured to the supporting frames 21A through 21D.

<Second Step>

The position of the supporting frames 21A through 21D relative to the lens holder frame 23 is adjusted so that the emission axes of the LDs 20A through 20D are made coincident with the optical axes of the corresponding collimator lenses 22A through 22D. Thereafter, the supporting frames 21A through 21D are secured to the lens holder frame 23 by screws.

<Third Step>

The lead wires 2 of the LDs 20A through 20D are inserted in the corresponding guide holes 32 of the guide member 30. In this state, the lens holder frame 23 is integral with the guide member 30.

<Fourth Step>

The lead wires 2 of the LDs 20A through 20D which extend from the guide holes 32 of the guide member 30 are inserted in the corresponding insertion holes 27 of the LD drive circuit board 26.

<Fifth Step>

The lead wires 2 of the LDs 20A through 20D are connected to the circuit pattern of the LD drive circuit board 26 by soldering or the like.

The assembling operation mentioned above is given by way of example and can be modified. In an alternative, for example, the third and fourth steps are replaced with the following modified third and fourth steps, respectively.

<Modified Third Step>

The guide member 30 is secured to the LD drive circuit board 26 while the small openings 32b of the guide holes 32 are registered with the corresponding insertion holes 27.

<Modified Fourth Step>

The lead wires 2 of the LDs 20A through 20D are inserted in the corresponding guide holes 32 and in the insertion holes 27 of the LD drive circuit board 26.

As mentioned above, in the arrangement wherein the LDs 20A through 20D are connected to the LD drive circuit board 26 through the guide member 30, it is not necessary to provide an LD drive circuit board for each LD unlike the prior art. Consequently, the apparatus thereof can be made small. Furthermore, unlike the prior art, since it is not necessary to connect the LDs to each LD drive circuit board using a flexible circuit board, deterioration of the output properties of the LDs does not occur.

The shape of the guide holes 32 is not limited to that in the illustrated embodiment, as long as the diameter thereof at the second surface of the guide member opposed to the LD drive circuit board 26 is smaller than the diameter at the first surface of the guide member opposed to the LDs 20A through 20D. It is, however, desirable that the guide holes 32 be tapered so that no or little bending of the lead wires of the LDs 20A through 20D occurs in the tapered guide holes 32.

Although the above discussion has been addressed to an embodiment of a guide member and a circuit board mounting method, applied to a multi-beam scanning optical system 10 having a plurality of LDs 20A through 20D, the present invention is not limited thereto. For instance, the guide member and the circuit board mounting method can be applied to an optical scanner having a single LD. In an optical scanner having a single LD, the lead wires of the LD may be bent during assembling operation. This problem can be advantageously eliminated by the present invention.

According to a guide member of the present invention, a plurality of light emitting elements can be mounted to a single drive circuit board. Consequently, not only can the apparatus be made small, but also a high performance of the light emitting elements can be maintained.

Obvious changes may be made in the specific embodiments of the present invention described herein, such modifications being within the spirit and scope of the invention claimed. It is indicated that all matter contained herein is illustrative and does not limit the scope of the present invention.

What is claimed is:

1. A guide member provided between at least one light emitting element located at a predetermined position and a circuit board,
wherein said light emitting element is provided with a plurality of lead wires,
wherein said circuit board is provided with a plurality of insertion holes in which a plurality of said lead wires of the light emitting element are inserted, respectively, and
wherein said guide member is provided with a plurality of guide holes through which each lead wire of the light emitting element is guided into each corresponding insertion hole of said plurality of insertion holes of the circuit board.

2. The guide member according to claim 1, wherein said guide holes extend through the guide member from a first surface of the guide member adjacent to the light emitting element to a second surface of the guide member adjacent to the circuit board, the diameter of the guide hole at the second surface being smaller than the diameter of the guide hole at the first surface.

3. The guide member according to claim 2, wherein said guide holes are tapered so that the diameter thereof is decreased from the first surface of the guide member adjacent to the light emitting element toward the second surface of the guide member adjacent to the circuit board.

4. The guide member according to claim 2, wherein the diameter of the guide hole at the second surface is not greater than the diameter of the insertion holes.

5. A mounting method for mounting at least one light emitting element to a circuit board by inserting a plurality of lead wires of the light emitting element in corresponding insertion holes formed in the circuit board, wherein a guide member is provided between the light emitting element and the circuit board, said guide member being provided with a plurality of tapered guide holes whose diameter is reduced from a first surface of the guide member opposed to the light emitting element toward a second surface thereof opposed to the circuit board, said mounting method comprising:
inserting each lead wire of the light emitting element into the corresponding guide hole of the guide member, and
inserting the lead wires extending from the guide holes into the corresponding insertion holes of the circuit board.

6. The mounting method for mounting a light emitting element to a circuit board according to claim 5, wherein said light emitting element is mounted to said guide member in advance by inserting the lead wires of the light emitting element into the corresponding guide holes of the guide member, and thereafter, the lead wires extending from the guide holes are inserted in the corresponding insertion holes.

7. The mounting method for mounting a light emitting element to a circuit board according to claim 5, wherein said guide member is secured to said circuit board in advance so that the guide holes in the second surface of the guide member are registered with the corresponding insertion holes of the circuit board, and thereafter, the lead wires of the light emitting elements are inserted in the corresponding insertion holes by inserting the lead wires in the corresponding guide holes.
